(19) United States
(12) Patent Application Publication
(10) Pub. No.: US 2025/0389233 A1
(43) Pub. Date: Dec. 25, 2025

(54) INTERNAL-COMBUSTION-ENGINE CONTROL APPARATUS AND METHOD OF CONTROLLING INTERNAL COMBUSTION ENGINE

(71) Applicant: SUBARU CORPORATION, Tokyo (JP)

(72) Inventor: Madoka IIZUKA, Tokyo (JP)

(21) Appl. No.: 19/230,260

(22) Filed: Jun. 6, 2025

(30) Foreign Application Priority Data
Jun. 25, 2024 (JP) 2024-102002

(51) Int. Cl. F02D 41/14; F01N 11/00; F02D 41/00

(52) U.S. Cl. CPC F02D 41/1486; F01N 11/007; F02D 41/005; F02D 41/0077; F01N 2900/1402

(57) ABSTRACT

An internal-combustion-engine control apparatus configured to control an internal combustion engine includes an exhaust gas recirculation processor and a catalyst neutralization processor. The exhaust gas recirculation processor is configured to control an exhaust gas recirculator, based on an operating state of the internal combustion engine. The catalyst neutralization processor is configured to: determine whether an oxygen concentration detected by an oxygen sensor is greater than or equal to a predetermined first threshold; and execute, when the oxygen concentration detected by the oxygen sensor is greater than or equal to the predetermined first threshold, catalyst neutralization processing in which fuel injection into the internal combustion engine is executed in a fuel-rich atmosphere having a richer air-fuel ratio than a stoichiometric air-fuel ratio to thereby consume at least a part of oxygen stored in a catalyst.

### CROSS-REFERENCE TO RELATED APPLICATIONS

The present application claims priority from Japanese Patent Application No. 2024-102002 filed on June 25, 2024, the entire contents of which are hereby incorporated by reference.

### BACKGROUND

The disclosure relates to an internal-combustion-engine control apparatus and a method of controlling an internal combustion engine.

An internal combustion engine includes an exhaust passage provided with a catalyst that purifies exhaust gas. In a case of a gasoline engine, the exhaust passage is provided with a three-way catalyst including a ceramic carrier that supports noble metal such as platinum, rhodium, or palladium. The three-way catalyst purifies carbon monoxide (CO), a nitrogen oxide (NOx), and a hydrocarbon (HC) in the exhaust gas.

If a fuel cut is executed to temporarily stop fuel injection when the internal combustion engine is operating, the three-way catalyst increases in internal oxygen concentration and decreases in capability of purifying NOx. If the fuel injection is resumed after termination of the fuel cut, the three-way catalyst gradually decreases in the oxygen concentration and is neutralized; however, the three-way catalyst decreases in the capability of purifying NOx until being neutralized. To address this, when the oxygen concentration is low on a downstream side of the three-way catalyst, so-called catalyst neutralization processing is executed. In the catalyst neutralization processing, the three-way catalyst is supplied with an excess fuel by setting an air-fuel ratio (A/F) of the exhaust gas to a rich A/F, to thereby oxidize oxygen stored in the three-way catalyst. For example, reference is made to Japanese Unexamined Patent Application Publication No. 2018-35796.

### SUMMARY

An aspect of the disclosure provides an internal-combustion-engine control apparatus configured to control an internal combustion engine. The internal combustion engine includes: an internal combustion engine body; an intake passage and an exhaust passage each coupled to the internal combustion engine body; a catalyst provided in the exhaust passage; an oxygen sensor configured to detect an oxygen concentration on a downstream side of the catalyst; and an exhaust gas recirculator configured to circulate a part of exhaust gas into the intake passage. The internal-combustion-engine control apparatus includes an exhaust gas recirculation processor and a catalyst neutralization processor. The exhaust gas recirculation processor is configured to control the exhaust gas recirculator, based on an operating state of the internal combustion engine. The catalyst neutralization processor is configured to: determine whether the oxygen concentration detected by the oxygen sensor is greater than or equal to a predetermined first threshold; execute, when the oxygen concentration detected by the oxygen sensor is greater than or equal to the predetermined first threshold, catalyst neutralization processing in which fuel injection into the internal combustion engine is executed in a fuel-rich atmosphere having a richer air-fuel ratio than a stoichiometric air-fuel ratio to thereby consume at least a part of oxygen stored in the catalyst; determine whether the oxygen concentration detected by the oxygen sensor in a predetermined time period after the fuel injection is resumed following termination of a fuel cut has increased from a value less than a predetermined second threshold to a value greater than or equal to the predetermined second threshold, the fuel cut being configured to stop the fuel injection when the internal combustion engine is operating, the predetermined second threshold being set less than the predetermined first threshold; and correct, when the oxygen concentration detected by the oxygen sensor in the predetermined time period after the fuel injection is resumed following the termination of the fuel cut has increased to the value greater than or equal to the predetermined second threshold, an operation amount of the exhaust gas recirculator to reduce an exhaust gas recirculation amount.

An aspect of the disclosure provides a method of controlling an internal combustion engine. The internal combustion engine includes: an internal combustion engine body; an intake passage and an exhaust passage each coupled to the internal combustion engine body; a catalyst provided in the exhaust passage; an oxygen sensor configured to detect an oxygen concentration on a downstream side of the catalyst; and an exhaust gas recirculator configured to circulate a part of exhaust gas into the intake passage. The method includes: controlling the exhaust gas recirculator, based on an operating state of the internal combustion engine; determining whether the oxygen concentration detected by the oxygen sensor is greater than or equal to a predetermined first threshold; executing, when the oxygen concentration detected by the oxygen sensor is greater than or equal to the predetermined first threshold, catalyst neutralization processing in which fuel injection into the internal combustion engine is executed in a fuel-rich atmosphere having a richer air-fuel ratio than a stoichiometric air-fuel ratio to thereby consume at least a part of oxygen stored in the catalyst; determining whether the oxygen concentration detected by the oxygen sensor in a predetermined time period after the fuel injection is resumed following termination of a fuel cut has increased from a value less than a predetermined second threshold to a value greater than or equal to the predetermined second threshold, the fuel cut being configured to stop the fuel injection when the internal combustion engine is operating, the predetermined second threshold being set less than the predetermined first threshold; and correcting, when the oxygen concentration detected by the oxygen sensor in the predetermined time period after the fuel injection is resumed following the termination of the fuel cut has increased to the value greater than or equal to the predetermined second threshold, an operation amount of the exhaust gas recirculator to reduce an exhaust gas recirculation amount.

An aspect of the disclosure provides an internal-combustion-engine control apparatus configured to control an internal combustion engine. The internal combustion engine includes: an internal combustion engine body; an intake passage and an exhaust passage each coupled to the internal combustion engine body; a catalyst provided in the exhaust passage; an oxygen sensor configured to detect an oxygen concentration on a downstream side of the catalyst; and an exhaust gas recirculator configured to circulate a part of exhaust gas into the intake passage. The internal-combustion-engine control apparatus includes circuitry. The circuitry is configured to: control the exhaust gas recirculator, based on an operating state of the internal combustion engine; determine whether the oxygen concentration detected by the oxygen sensor is greater than or equal to a predetermined first threshold; execute, when the oxygen concentration detected by the oxygen sensor is greater than or equal to the predetermined first threshold, catalyst neutralization processing in which fuel injection into the internal combustion engine is executed in a fuel-rich atmosphere having a richer air-fuel ratio than a stoichiometric air-fuel ratio to thereby consume at least a part of oxygen stored in the catalyst; determine whether the oxygen concentration detected by the oxygen sensor in a predetermined time period after the fuel injection is resumed following termination of a fuel cut has increased from a value less than a predetermined second threshold to a value greater than or equal to the predetermined second threshold, the fuel cut being configured to stop the fuel injection when the internal combustion engine is operating, the predetermined second threshold being set less than the predetermined first threshold; and correct, when the oxygen concentration detected by the oxygen sensor in the predetermined time period after the fuel injection is resumed following the termination of the fuel cut has increased to the value greater than or equal to the predetermined second threshold, an operation amount of the exhaust gas recirculator to reduce an exhaust gas recirculation amount.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a schematic diagram illustrating an exemplary configuration of an internal combustion engine to which an internal-combustion-engine control apparatus according to one example embodiment of the disclosure is applicable.

FIG. 2 is a block diagram illustrating an exemplary configuration of the internal-combustion-engine control apparatus illustrated in FIG. 1.

FIG. 3 is a flowchart illustrating an exemplary method of controlling the internal combustion engine illustrated in FIG. 1.

FIG. 4 is another flowchart illustrating the exemplary method of controlling the internal combustion engine illustrated in FIG. 1.

FIG. 5 is an explanatory diagram illustrating exemplary workings of the internal-combustion-engine control apparatus illustrated in FIGS. 1 and 2.

FIG. 6 is an explanatory diagram illustrating an example to which the internal-combustion-engine control apparatus illustrated in FIGS. 1 and 2 is not applied.

FIG. 7 is an explanatory diagram illustrating an example to which the internal-combustion-engine control apparatus illustrated in FIGS. 1 and 2 is applied.

### DETAILED DESCRIPTION

An internal combustion engine includes an exhaust gas recirculation (EGR) system that circulates a part of exhaust gas into an intake passage. The EGR system mixes the part of the exhaust gas having a low oxygen concentration into intake air to thereby decrease an oxygen concentration of the intake air, resulting in a decrease in combustion temperature and a reduction in generation amount of NOx. If catalyst neutralization processing is executed when fuel injection is resumed after termination of a fuel cut, the internal combustion engine is supplied with a small amount of air. This leads to a significantly low EGR amount of the exhaust gas controlled by the EGR system in the catalyst neutralization processing.

Meanwhile, if an execution time period of the fuel cut is markedly short, the catalyst neutralization processing may be started at a delayed timing after the termination of the fuel cut. In this case, a decrease in oxygen concentration ascribed to a fuel-rich state produced by the catalyst neutralization processing coincides with a decrease in oxygen concentration attributed to the exhaust gas introduced by the EGR system (i.e., EGR gas), resulting in a significant drop in oxygen concentration. This drop can cause a stall of the internal combustion engine.

It is desirable to suppress a stall of an internal combustion engine caused by catalyst neutralization processing.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

### 1. Overall Configuration of Internal Combustion Engine

First, a description will be given of an overall configuration of an internal combustion engine to which an internal-combustion-engine control apparatus according to an example embodiment of the disclosure is applicable.

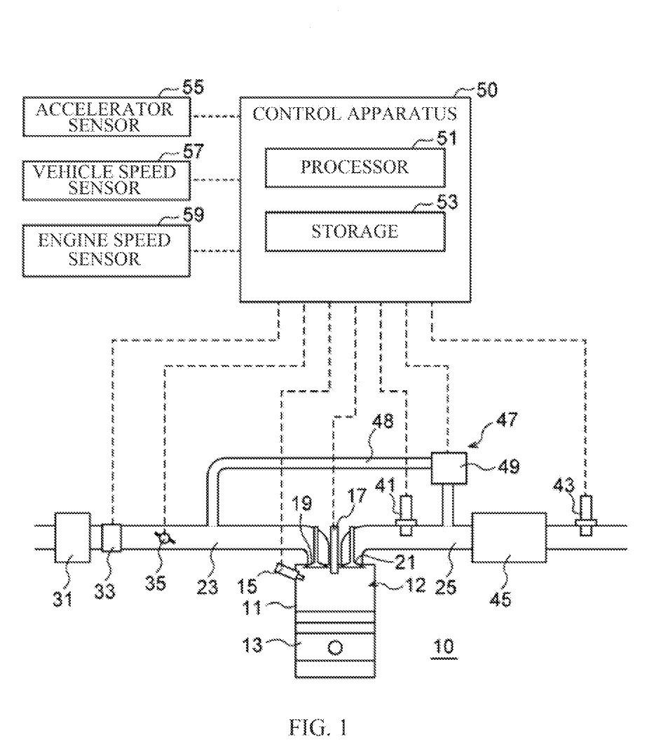

FIG. 1 is a schematic diagram illustrating an exemplary overall configuration of an internal combustion engine 10. The internal combustion engine 10 illustrated in FIG. 1 may be an engine, such as a spark-ignition direct-injection gasoline engine, mounted in a vehicle such as an automobile. The internal combustion engine 10 may include an internal combustion engine body including one or more cylinders 11. To facilitate understanding, FIG. 1 simply illustrates one of the cylinders 11.

The cylinder 11 may include a piston 13. The piston 13 may be slidable in the cylinder 11. Inside a part of the cylinder 11, a combustion chamber 12 may be defined by an inner circumferential surface of the cylinder 11 and a top surface of the piston 13. The cylinder 11 may be provided with a fuel injector 15 and a spark plug 17. The fuel injector 15 may be an injection device that injects atomized fuel directly into the combustion chamber 12 of the cylinder 11. The fuel injector 15 may be supplied with the fuel from an unillustrated fuel supply device, and inject the fuel by opening its valve in accordance with a signal outputted from a control apparatus 50. The spark plug 17 may generate a spark in accordance with a signal outputted from the control apparatus 50 to thereby ignite an air-fuel mixture formed in the cylinder 11. This may cause the piston 13 to reciprocate, rotating a crankshaft coupled to the piston 13 via an unillustrated connecting rod. As a result, drive torque may be outputted.

To the cylinder 11 may be coupled an intake passage 23 and an exhaust passage 25. The intake passage 23 may be provided with an air filter 31, an air flow meter 33, and a throttle valve 35 in order from an upstream side of a flow of intake air. The air filter 31 may remove foreign matter present in the intake air to be introduced. The air flow meter 33 may measure a flow rate of the intake air to be introduced. The throttle valve 35 may be driven by the control apparatus 50 to regulate an opening area of the intake passage 23 and thereby adjust the flow rate of the intake air to be introduced into the cylinder 11 through the intake passage 23. The intake passage 23 may be coupled to the cylinder 11 at its opening provided with an intake valve 19. The intake valve 19 may open and close the opening in conjunction with the rotation of the crankshaft of the internal combustion engine 10.

The exhaust passage 25 may be provided with an air-fuel ratio (A/F) sensor 41, an oxygen sensor 43, and a three-way catalyst 45. The A/F sensor 41 may measure an A/F of exhaust gas on an upstream side of the three-way catalyst 45. The oxygen sensor 43 may measure an oxygen concentration of the exhaust gas on a downstream side of the three-way catalyst 45. In the present example embodiment, the A/F sensor 41 and the oxygen sensor 43 may each output a higher voltage value as the oxygen concentration of the exhaust gas is lower. Note that the A/F sensor 41 and the oxygen sensor 43 may be each any type of sensor configured to measure the oxygen concentration.

The three-way catalyst 45 may purify the exhaust gas by oxidizing a hydrocarbon (HC) and carbon monoxide (CO) in the exhaust gas respectively to water vapor (H2O) and carbon dioxide (CO2) and reducing a nitrogen oxide (NOx) in the exhaust gas to nitrogen (N2). In some embodiments, the three-way catalyst 45 may serve as a gasoline particulate filter (GPF) that collects particulate matter (PM) in the exhaust gas, in addition to or instead of acting as a catalyst.

The internal combustion engine 10 further includes an exhaust gas recirculation (EGR) device 47. The EGR device 47 may include: an EGR passage 48 that couples the exhaust passage 25 and the intake passage 23 to each other; and an EGR valve 49 that regulates an opening area of the EGR passage 48. The EGR valve 49 may be controlled by the control apparatus 50, based on an operating state of the internal combustion engine 10, to regulate the opening area and thereby adjust a flow rate of the exhaust gas to be circulated from the exhaust passage 25 into the intake passage 23. In the present example embodiment, the EGR passage 48 may be coupled to the exhaust passage 25 on the upstream side of the three-way catalyst 45; however, this is non-limiting. In some embodiments, the EGR passage 48 may be coupled to the exhaust passage 25 on the downstream side of the three-way catalyst 45. In one embodiment, the EGR device 47 may serve as an "exhaust gas recirculator".

The control apparatus 50 may include a processor such as a central processing unit (CPU), and a storage including a memory such as a random-access memory (RAM) or a read-only memory (ROM). The control apparatus 50 may be configured to control an operation of the internal combustion engine 10 when the processor executes a computer program. The computer program may be adapted to cause the processor to execute a later-described operation to be performed by the control apparatus 50. In some embodiments, the computer program to be executed by the processor may be contained in a recording medium serving as a storage (a memory) 53 included in the control apparatus 50. In some embodiments, the computer program to be executed by the processor may be contained in a recording medium incorporated in the control apparatus 50 or any external recording medium attachable to the control apparatus 50.

Non-limiting examples of the recording medium containing the computer program may include: a magnetic medium such as a hard disk, a floppy disk, or a magnetic tape; an optical recording medium such as a compact disc read-only memory (CD-ROM), a digital versatile disc (DVD), or Blu-ray (registered trademark); a magneto-optical medium such as a floptical disk; a memory such as a RAM or a ROM; a flash memory such as a universal serial bus (USB) memory or a solid state drive (SSD); and any other medium configured to contain a program.

In some embodiments, all or a part of the control apparatus 50 may include updatable software such as firmware. In some embodiments, all or a part of the control apparatus 50 may be a program module to be executed in accordance with a command from a device such as the CPU.

### 2. Internal-Combustion-Engine Control Apparatus

Next, the control apparatus 50 that controls the internal combustion engine 10 will be described.

The control apparatus 50 may set a control target of the internal combustion engine 10, based on data transmitted from various sensors, and control the operation of the internal combustion engine 10, based on the set control target. The control apparatus 50 may output control signals to components such as the throttle valve 35, the fuel injector 15, the spark plug 17, or the EGR valve 49, and control output torque and an engine speed.

The control apparatus 50 may be configured to acquire sensor signals from an accelerator sensor 55, a vehicle speed sensor 57, and an engine speed sensor 59, in addition to sensor signals from the air flow meter 33, the A/F sensor 41, and the oxygen sensor 43. The accelerator sensor 55 may detect an operation amount of an accelerator pedal operated by a driver who drives the vehicle. The vehicle speed sensor 57 may detect a vehicle speed of the vehicle. The engine speed sensor 59 may detect the engine speed as a rotation speed of the crankshaft of the internal combustion engine 10.

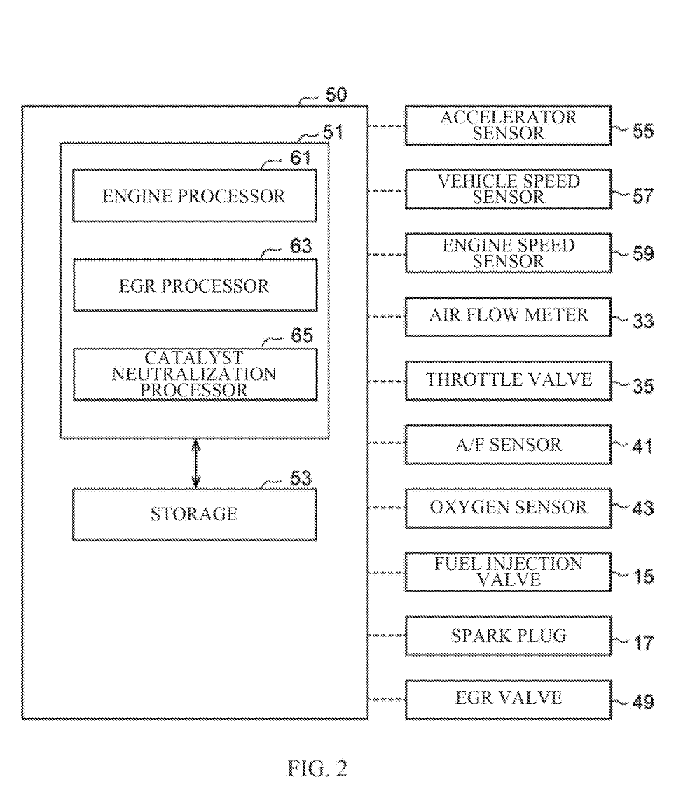

FIG. 2 is an explanatory diagram illustrating an exemplary configuration of the control apparatus 50 illustrated in FIG. 1. The control apparatus 50 may include a processor 51 and a storage 53. The processor 51 may include one or more processors such as a CPU. The storage 53 may be configured to communicate with the processor 51. The storage 53 may hold data including a program to be executed by the processor 51, various parameters to be used in calculation processes, detection data, and a calculation result. A part of the storage 53 may serve as a work area of the processor 51.

The control apparatus 50 may be configured to acquire the sensor signals outputted from the air flow meter 33, the A/F sensor 41, the oxygen sensor 43, the accelerator sensor 55, the vehicle speed sensor 57, and the engine speed sensor 59. In the illustrated example, the various sensors may be coupled directly to the control apparatus 50; however, this is non-limiting. In some embodiments, the control apparatus 50 may acquire data indicated by the sensor signals of the various sensors, from any other processor via an unillustrated in-vehicle network.

The processor 51 may include an engine processor 61, an EGR processor 63, and a catalyst neutralization processor 65. The respective operations of the engine processor 61, the EGR processor 63, and the catalyst neutralization processor 65 may be implemented when the processor 51 executes the computer program. In some embodiments, a part of the engine processor 61, the EGR processor 63, and the catalyst neutralization processor 65 may be hardware such as analog circuitry. In one embodiment, the EGR processor 63 may serve as an "exhaust gas recirculation processor".

### Engine Processor

The engine processor 61 may control the operation of the internal combustion engine 10. The engine processor 61 may set target torque serving as a target value of the output torque to be outputted from the internal combustion engine 10, and set a target intake-air amount, a target fuel injection amount, and a target ignition timing, based on the target torque. In the present example embodiment, the engine processor 61 may calculate the target torque, based on an accelerator position and the engine speed, referring to a torque map held in advance in the storage 53. In some embodiments where another drive component that uses the output torque of the internal combustion engine 10 is provided, the engine processor 61 may set the target torque additionally including the torque to be applied to the other drive component.

The engine processor 61 may further set the target intake-air amount, the target fuel injection amount, and the target ignition timing, referring to an intake-air amount map, an injection amount map, and an ignition timing map held in advance in the storage 53. The target intake-air amount may be a target value of an intake-air amount to be introduced into the cylinder 11 of the internal combustion engine 10, and may be set proportional to a magnitude of the target torque. The target fuel injection amount may be a target value of a fuel injection amount to be injected and supplied into the cylinder 11 by the fuel injector 15, and may be set in accordance with the target intake-air amount to cause an air-fuel mixture to have a constant A/F (a stoichiometric A/F). The target ignition timing may be a target value of a timing of igniting the air-fuel mixture formed in the cylinder 11. In one example, combustion efficiency of the air-fuel mixture may be lowered as the ignition timing is more retarded relative to a top dead center of the piston 13 of the internal combustion engine 10.

The engine processor 61 may control driving of the throttle valve 35, the fuel injector 15, and the spark plug 17, based on the set target intake-air amount, target fuel injection amount, and target ignition timing. This may control the engine speed and the output torque to be outputted from the internal combustion engine 10. In the present example embodiment, the engine processor 61 may set a target throttle position of the throttle valve 35, based on the target intake-air amount and the engine speed, and rotate the throttle valve 35. The engine processor 61 may further set a drive duty ratio of the fuel injector 15, based on the target fuel injection amount, and control an electric current to be supplied to the fuel injector 15. The engine processor 61 may further supply an electric current to the spark plug 17 in accordance with the target ignition timing.

The engine processor 61 may further execute a fuel cut that stops fuel injection into (i.e., fuel injection control of) the internal combustion engine 10, in accordance with a traveling state of the vehicle. In some embodiments, the engine processor 61 may execute the fuel cut when the vehicle is decelerating and the accelerator position is at zero. The engine processor 61 may terminate the fuel cut and resume the fuel injection when the accelerator position exceeds zero or the engine speed has decreased to a predetermined threshold.

### EGR Processor

The EGR processor 63 may control driving of the EGR valve 49, based on the operating state of the internal combustion engine 10. In the present example embodiment, the EGR processor 63 may determine a target EGR valve position (a target operation amount) of the EGR valve 49, referring to an EGR map in which the target EGR valve position is set in accordance with the engine speed and the target torque of the internal combustion engine 10, and control the EGR valve 49 to adjust its EGR valve position to the target EGR valve position. During the fuel cut, the EGR processor 63 may maintain the EGR valve 49 in a closed state. However, in some embodiments where diagnostic processing (i.e., self-diagnosis) of the EGR device 47 is to be executed, the EGR processor 63 may bring the EGR valve 49 into an open state during the fuel cut. The EGR processor 63 may also maintain the EGR valve 49 in the closed state during the catalyst neutralization processing.

### Catalyst Neutralization Processor

The catalyst neutralization processor 65 may execute the catalyst neutralization processing that consumes at least a part of oxygen stored in the three-way catalyst 45. The catalyst neutralization processor 65 determines whether the oxygen concentration detected by the oxygen sensor 43 (hereinafter referred to as a "downstream-side oxygen concentration") is greater than or equal to a predetermined first threshold. If the downstream-side oxygen concentration is greater than or equal to the predetermined first threshold, the catalyst neutralization processor 65 executes the fuel injection into the internal combustion engine 10 in a fuel-rich atmosphere having a richer A/F than the stoichiometric A/F to thereby consume the oxygen stored in the three-way catalyst 45.

The predetermined first threshold may be a threshold for the determination as to whether an amount of the oxygen stored in the three-way catalyst has become excessive, and may be set to any appropriate value. Normally, the amount of the oxygen stored in the three-way catalyst 45 may become excessive due to the execution of the fuel cut, and the downstream-side oxygen concentration may increase accordingly. The predetermined first threshold may be set to an appropriate value, based on the downstream-side oxygen concentration. In view of this, the catalyst neutralization processing may typically be executed when the fuel injection is resumed after the termination of the fuel cut.

The catalyst neutralization processor 65 further determines whether the downstream-side oxygen concentration detected by the oxygen sensor 43 in a predetermined time period after the fuel injection is resumed following the termination of the fuel cut has increased from a value less than a predetermined second threshold to a value greater than or equal to the predetermined second threshold. The predetermined second threshold is set less than the predetermined first threshold. If the downstream-side oxygen concentration has increased to the value greater than or equal to the predetermined second threshold, the catalyst neutralization processor 65 corrects an operation amount of the EGR valve 49 to reduce an EGR amount (i.e., executes an EGR amount reduction correction or EGR control). In one embodiment, the EGR amount may serve as an "exhaust gas recirculation amount".

The driver of the vehicle may execute the fuel cut for a short time period such as about one second to about three seconds by releasing the accelerator pedal for the short time period. In this case, the downstream-side oxygen concentration may exceed the predetermined first threshold after the fuel injection is resumed following the termination of the fuel cut. If the catalyst neutralization processing is executed at this timing, the EGR amount may remain substantially unchanged due to an operational delay of the EGR valve 49. This may cause a decrease in oxygen concentration ascribed to a fuel-rich state produced by the catalyst neutralization processing to coincide with a decrease in oxygen concentration attributed to EGR gas introduced by the EGR device 47, resulting in a significant drop in oxygen concentration. This drop may cause a stall of the internal combustion engine 10.

To address this, when the downstream-side oxygen concentration has increased from the value less than the predetermined second threshold to the value greater than or equal to the predetermined second threshold in the predetermined time period after the fuel injection is resumed following the termination of the fuel cut, the catalyst neutralization processor 65 may execute the EGR amount reduction correction in anticipation of a start of the catalyst neutralization processing. This may bring the EGR amount close to zero before the start of the catalyst neutralization processing, suppressing the stall of the internal combustion engine 10.

The predetermined second threshold may be set to a value exceeding a range of fluctuation of the downstream-side oxygen concentration occurring in traveling in a normal mode under the fuel injection control and the EGR control resumed after the termination of the catalyst neutralization processing. This may allow for a detection of a state where the downstream-side oxygen concentration is starting to increase even though the vehicle is traveling in the normal mode after the termination of the fuel cut.

In the present example embodiment, whether the downstream-side oxygen concentration is greater than or equal to the predetermined first threshold may correspond to whether an output voltage of the oxygen sensor 43 is less than or equal to a predetermined first voltage threshold. Further, whether the downstream-side oxygen concentration has increased from the value less than the predetermined second threshold to the value greater than or equal to the predetermined second threshold may correspond to whether the output voltage of the oxygen sensor 43 has decreased from a value exceeding a predetermined second voltage threshold to a value less than or equal to the predetermined second voltage threshold.

### 3. Exemplary Operation of Internal-Combustion-Engine Control Apparatus

Hereinabove, the exemplary configuration of the control apparatus 50 for the internal combustion engine 10 has been described. Next, an exemplary operation of the control apparatus 50 for the internal combustion engine 10 will be described.

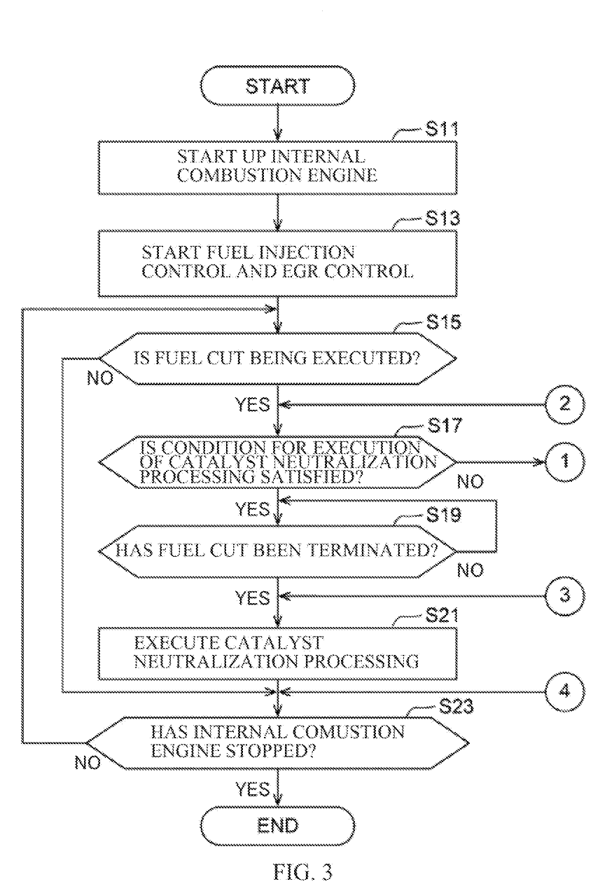

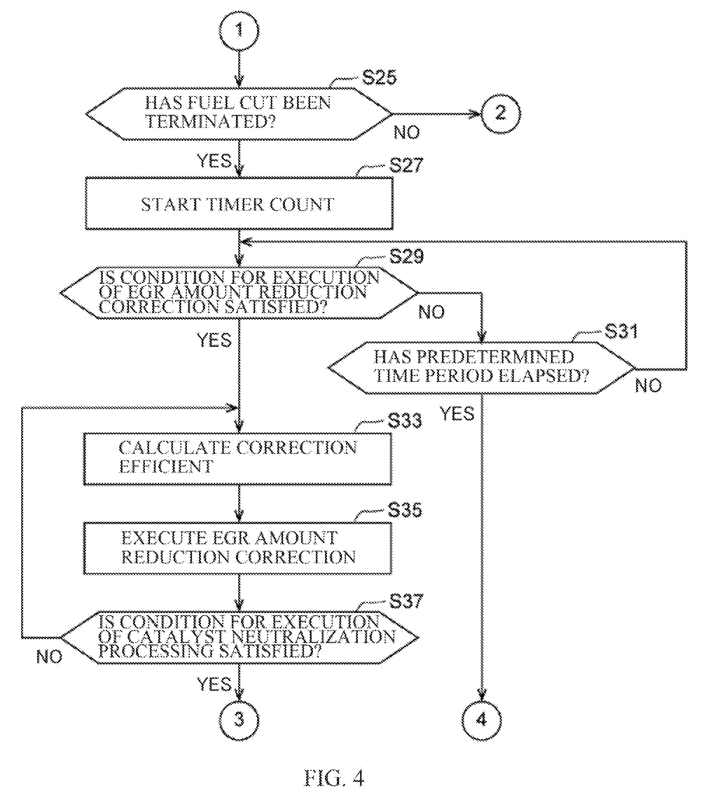

FIGS. 3 and 4 are each a flowchart illustrating an exemplary processing operation to be performed by the control apparatus 50. Note that the processing operation illustrated in the flowcharts of FIGS. 3 and 4 is constantly performed when the internal combustion engine 10 is in operation.

After starting up the internal combustion engine 10 (step S11), the engine processor 61 of the control apparatus 50 may start the fuel injection control and the EGR control of the internal combustion engine 10 (step S13). In the present example embodiment, the engine processor 61 may acquire the sensor signal of the accelerator sensor 55 and the sensor signal of the engine speed sensor 59, and calculate the target torque, based on the accelerator position and the engine speed. In some embodiments where the vehicle is traveling under automated driving control that automatedly controls an acceleration rate by a computer, the data on the accelerator position may be replaced by data on a requested acceleration rate set by the computer.

The engine processor 61 may set the target intake-air amount, the target fuel injection amount, and the target ignition timing, based on the set target torque. The EGR processor 63 may set the target EGR valve position (the target operation amount) of the EGR valve 49 in accordance with the engine speed and the target torque of the internal combustion engine 10. The engine processor 61 may control driving of the throttle valve 35, the fuel injector 15, the spark plug 17, and the EGR valve 49, based on the set target intake-air amount, target fuel injection amount, target ignition timing, and target EGR valve position.

Thereafter, the catalyst neutralization processor 65 may determine whether the fuel cut for the internal combustion engine 10 is being executed (step S15). If determining that the fuel cut for the internal combustion engine 10 is not being executed (step S15: NO), the catalyst neutralization processor 65 may cause the flow to proceed to step S23, and repeat the determination in step S15 until determining that the internal combustion engine 10 has stopped.

If determining that the fuel cut for the internal combustion engine 10 is being executed (step S15: YES), the catalyst neutralization processor 65 may determine whether a condition for the execution of the catalyst neutralization processing is satisfied (step S17). In the present example embodiment, for the determination as to whether the condition for the execution of the catalyst neutralization processing is satisfied, the catalyst neutralization processor 65 may determine whether the downstream-side oxygen concentration measured by the oxygen sensor 43 is greater than or equal to the predetermined first threshold. In some embodiments, the catalyst neutralization processor 65 may determine whether the output voltage of the oxygen sensor 43 is less than or equal to the predetermined first voltage threshold corresponding to the predetermined first threshold of the downstream-side oxygen concentration. During the fuel cut, the fuel injection control may be stopped and the EGR valve 49 may be maintained in the closed state. However, in some embodiments where the diagnostic processing of a fuel injection system or the EGR device 47 is to be executed, a minute amount of the fuel may be injected or the EGR valve 49 may be brought into the open state during the fuel cut.

If determining that the downstream-side oxygen concentration is greater than or equal to the predetermined first threshold and the condition for the execution of the catalyst neutralization processing is satisfied (step S17: YES), the catalyst neutralization processor 65 may set a condition satisfaction flag, and determine whether the fuel cut has been terminated (step S19). If determining that the fuel cut has not been terminated (step S19: NO), the catalyst neutralization processor 65 may repeat the determination in step S19 until the fuel cut is terminated.

If determining that the fuel cut has been terminated (step S19: YES), the catalyst neutralization processor 65 may execute the catalyst neutralization processing (step S21). When the fuel injection control is resumed after the termination of the fuel cut, the catalyst neutralization processor 65 may execute the fuel injection into the internal combustion engine 10 in the fuel-rich atmosphere having the richer A/F than the stoichiometric A/F. This may supply the unburnt fuel to the three-way catalyst 45 to thereby consume the oxygen stored in the three-way catalyst 45.

If determining that the downstream-side oxygen concentration is less than the predetermined first threshold and the condition for the execution of the catalyst neutralization processing is not satisfied (steps S17: NO), the catalyst neutralization processor 65 may determine whether the fuel cut has been terminated (step S25). If determining that the fuel cut has not been terminated (step S25: NO), the catalyst neutralization processor 65 may return the flow to step S17. If the condition for the execution of the catalyst neutralization processing is satisfied before the fuel cut is terminated, the catalyst neutralization processor 65 may cause the flow to proceed to step S19.

If determining that the fuel cut has been terminated (step S25: YES), the catalyst neutralization processor 65 may start a timer count (step S27), and determine whether a condition for the execution of the EGR amount reduction correction that corrects the operation amount of the EGR valve 49 to reduce the EGR amount is satisfied (step S29). In the present example embodiment, for the determination as to whether the condition for the execution of the EGR amount reduction correction is satisfied, the catalyst neutralization processor 65 may determine whether the downstream-side oxygen concentration detected by the oxygen sensor 43 has increased from the value less than the predetermined second threshold to the value greater than or equal to the predetermined second threshold. In some embodiments, the catalyst neutralization processor 65 may determine whether the output voltage of the oxygen sensor 43 is less than or equal to the predetermined second voltage threshold corresponding to the predetermined second threshold of the downstream-side oxygen concentration. In step S29, the determination may be performed to identify whether the catalyst neutralization processing is to be executed based on an estimation that the downstream-side oxygen concentration is to become greater than or equal to the predetermined first threshold.

If determining that the downstream-side oxygen concentration continues to be less than the predetermined second threshold and the condition for the execution of the EGR amount reduction correction is not satisfied (step S29: NO), the catalyst neutralization processor 65 may determine whether a predetermined time period has elapsed after the start of the timer count in step S27 (step S31). In some embodiments, the predetermined time period may be set to any appropriate value calculated in advance by a method such as a simulation with an actual device in light of a time period in which the downstream-side oxygen concentration is estimated to increase due to the fuel cut executed for a short time period.

If determining that the predetermined time period has elapsed (step S31: YES), the catalyst neutralization processor 65 may cause the flow to proceed directly to step S23, because the catalyst neutralization processing is not expected to start. If determining that the predetermined time period has not elapsed (step S31: NO), the catalyst neutralization processor 65 may return the flow to step S29, and repeat the determination as to whether the condition for the execution of the EGR amount reduction correction is satisfied until the predetermined time period elapses. If determining that the downstream-side oxygen concentration has increased from the value less than the predetermined second threshold to the value greater than or equal to the predetermined second threshold and the condition for the execution of the EGR amount reduction correction is satisfied (step S29: YES), the catalyst neutralization processor 65 may calculate a correction coefficient for an operation amount of the EGR device 47 (step S33).

The target EGR valve position of the EGR valve 49 can be set to zero when the condition for the execution of the EGR amount reduction correction is satisfied. This, however, can lower fuel economy due to a shorter time period for the execution of the EGR control. In the present example embodiment, the catalyst neutralization processor 65 may set the correction coefficient by linear interpolation in accordance with the downstream-side oxygen concentration, provided that the correction coefficient for the downstream-side oxygen concentration at the predetermined first threshold is defined as zero and the correction coefficient for the downstream-side oxygen concentration at the predetermined second threshold is defined as one. This may decrease the EGR amount as a timing of starting the catalyst neutralization processing approaches, to thereby bring the EGR amount close to zero at the timing of starting the catalyst neutralization processing. In this way, the EGR control may continue until the catalyst neutralization processing starts, suppressing the decrease in fuel economy.

In the present example embodiment, the catalyst neutralization processor 65 may execute the EGR amount reduction correction on condition that the vehicle is traveling in the normal mode without performing the fuel cut. This condition may be set not to hinder the self-diagnosis of the EGR device 47 accompanied by bringing the EGR valve 49 into the open state from being executed in performing the fuel-cut.

After calculating the correction coefficient, the catalyst neutralization processor 65 may execute the EGR amount reduction correction (step S35). In some embodiments, the EGR processor 63 may set the corrected target EGR valve position of the EGR valve 49 by multiplying the target EGR valve position calculated referring to the EGR map by the correction coefficient, and control the driving of the EGR valve 49 accordingly.

Thereafter, the catalyst neutralization processor 65 may determine whether the condition for the execution of the catalyst neutralization processing is satisfied (step S37). In the present example embodiment, for the determination as to whether the condition for the execution of the catalyst neutralization processing is satisfied, the catalyst neutralization processor 65 may determine whether the downstream-side oxygen concentration measured by the oxygen sensor 43 is greater than or equal to the predetermined first threshold. If determining that the downstream-side oxygen concentration is less than the predetermined first threshold and the condition for the execution of the catalyst neutralization processing is not satisfied (step S37: NO), the catalyst neutralization processor 65 may return the flow to step S33, and continue the EGR amount reduction correction. If the downstream-side oxygen concentration is greater than or equal to the predetermined first threshold and the condition for the execution of the catalyst neutralization processing is satisfied (step S37: YES), the catalyst neutralization processor 65 may execute the catalyst neutralization processing (step S21).

The processes in steps S15 to S37 described above may continue until the internal combustion engine 10 stops operating.

### 4. Workings

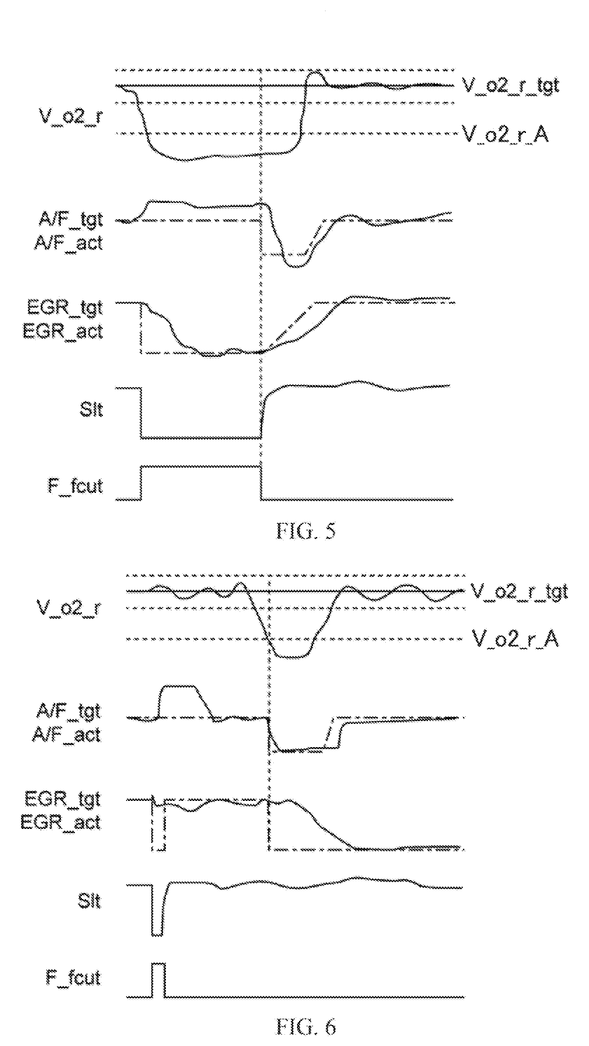

Next, exemplary workings of the control apparatus 50 according to the present example embodiment of the disclosure will be described with reference to FIGS. 5 to 7.

FIG. 5 is a diagram illustrating an example of a fuel-cut flag F_fcut, a throttle position Slt, a target EGR amount EGR_tgt, an actual EGR amount EGR_act, a target air-fuel ratio A/F_tgt, an actual air-fuel ratio A/F_act, and an output voltage V_o2_r of the oxygen sensor 43 in a situation where the catalyst neutralization processing is executed after the downstream-side oxygen concentration becomes greater than or equal to the predetermined first threshold in performing the fuel cut. The internal combustion engine 10 may be subjected to feedback control when the vehicle is traveling in the normal mode. In the feedback control, the output voltage V_o2_r of the oxygen sensor 43 may be brought to a target value V_o2_r_tgt by setting the A/F of the exhaust gas to an A/F that enhances purification efficiency of the three-way catalyst 45.

In the example illustrated in FIG. 5, upon setting the fuel-cut flag F_fcut, the throttle position Slt may decrease to stop the fuel injection, and the actual air-fuel ratio A/F_act may increase accordingly. This may increase the amount of the oxygen stored in the three-way catalyst 45, to thereby decrease the output voltage V_o2_r of the oxygen sensor 43. When the output voltage V_o2_r of the oxygen sensor 43 has become less than or equal to a predetermined first voltage threshold V_o2_r_A corresponding to the predetermined first threshold of the downstream-side oxygen concentration, the fuel injection may be resumed in a fuel-rich atmosphere having a lower target air-fuel ratio A/F_tgt after the termination of the fuel cut, to thereby consume the oxygen stored in the three-way catalyst 45. The target EGR amount EGR_tgt may be set to zero at the start of the fuel cut, and the actual EGR amount EGR_act may gradually decrease with the operational delay accordingly. The actual EGR amount EGR_act may become zero at the start of the catalyst neutralization processing, avoiding a significant drop in oxygen concentration of the intake air in executing the catalyst neutralization processing. This prevents the stall of the internal combustion engine 10.

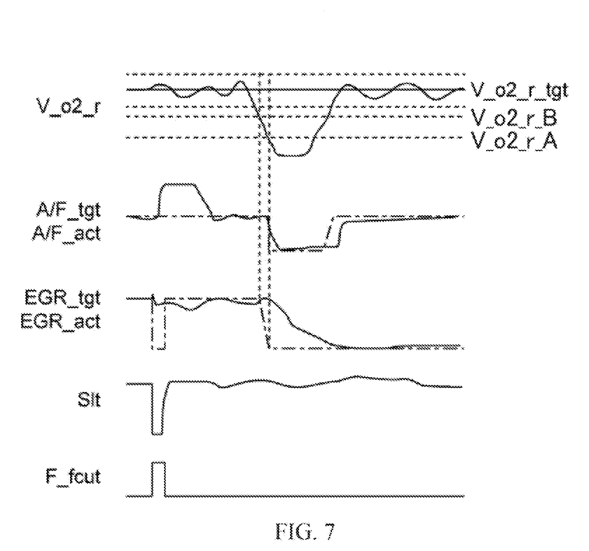

FIGS. 6 and 7 are each a diagram illustrating an example of the fuel-cut flag F_fcut, the throttle position Slt, the target EGR amount EGR_tgt, the actual EGR amount EGR_act, the target air-fuel ratio A/F_tgt, the actual air-fuel ratio A/F_act, and the output voltage V_o2_r of the oxygen sensor 43 in a situation where the catalyst neutralization processing is executed when the downstream-side oxygen concentration becomes greater than or equal to the predetermined first threshold at a delayed timing after the termination of the fuel cut performed for a short time period. Illustrated in FIG. 6 is an example in which the EGR amount reduction correction according to the present example embodiment is not executed. Illustrated in FIG. 7 is an example in which the EGR amount reduction correction according to the present example embodiment is executed.

In the examples illustrated in FIGS. 6 and 7 as well, upon setting the fuel-cut flag F_fcut, the throttle position Slt may decrease to stop the fuel injection, and the actual air-fuel ratio A/F_act may increase accordingly. The target EGR amount EGR_tgt may be set to zero at the start of the fuel cut but reset to its original value after a short time period, and the actual EGR amount EGR_act may remain substantially unchanged without significantly decreasing due to the operational delay.

In the example illustrated in FIG. 6, the EGR amount reduction correction may not be executed. Accordingly, even though the target EGR amount EGR_tgt is set to zero when the output voltage V_o2_r of the oxygen sensor 43 has become less than or equal to the predetermined first voltage threshold V_o2_r_A corresponding to the predetermined first threshold of the downstream-side oxygen concentration, the actual EGR amount EGR_act may not immediately decrease due to the operational delay. This may cause the decrease in oxygen concentration ascribed to the fuel-rich state produced by the catalyst neutralization processing to coincide with the decrease in oxygen concentration attributed to the EGR control, resulting in the stall of the internal combustion engine 10.

In contrast, in the example illustrated in FIG. 7, the EGR amount reduction correction may be executed. Accordingly, when the output voltage V_o2_r of the oxygen sensor 43 has decreased from a value exceeding a predetermined second voltage threshold V_o2_r_B corresponding to the predetermined second threshold of the downstream-side oxygen concentration to a value less than or equal to the predetermined second voltage threshold V_o2_r_B before becoming less than or equal to the predetermined first voltage threshold V_o2_r_A corresponding to the predetermined first threshold of the downstream-side oxygen concentration, the target EGR amount EGR_tgt may be corrected and decreased. This may allow the actual EGR amount EGR_act to start decreasing before the output voltage V_o2_r of the oxygen sensor 43 becomes less than or equal to the predetermined first voltage threshold V_o2_r_A, preventing the oxygen concentration of the intake air from dropping due to the coincidence between the decrease in oxygen concentration ascribed to the fuel-rich state produced by the catalyst neutralization processing and the decrease in oxygen concentration attributed to the EGR control. This helps to suppress the stall of the internal combustion engine 10.

### 5. Example Effects

In the example embodiment described above, the control apparatus 50 for the internal combustion engine 10 includes the EGR processor 63 and the catalyst neutralization processor 65. The EGR processor 63 is configured to control the EGR device 47, based on the operating state of the internal combustion engine 10. The catalyst neutralization processor 65 is configured to determine whether the downstream-side oxygen concentration detected by the oxygen sensor 43 is greater than or equal to the predetermined first threshold. The catalyst neutralization processor 65 is configured to, when the downstream-side oxygen concentration detected by the oxygen sensor 43 is greater than or equal to the predetermined first threshold, execute the catalyst neutralization processing in which the fuel injection into the internal combustion engine 10 is executed in the fuel-rich atmosphere to thereby consume at least a part of the oxygen stored in the three-way catalyst 45. The catalyst neutralization processor 65 is configured to determine whether the downstream-side oxygen concentration detected by the oxygen sensor 43 in the predetermined time period after the fuel injection is resumed following the termination of the fuel cut has increased from the value less than the predetermined second threshold to the value greater than or equal to the predetermined second threshold. The fuel cut is configured to stop the fuel injection when the internal combustion engine 10 is operating. The predetermined second threshold is set less than the predetermined first threshold. The catalyst neutralization processor 65 is configured to, when the downstream-side oxygen concentration detected by the oxygen sensor 43 in the predetermined time period after the fuel injection is resumed following the termination of the fuel cut has increased to the value greater than or equal to the predetermined second threshold, correct the operation amount of the EGR device 47 to reduce the actual EGR amount. Such a configuration helps to prevent the oxygen concentration of the intake air from dropping due to the coincidence between the decrease in oxygen concentration ascribed to the fuel-rich state produced by the catalyst neutralization processing and the decrease in oxygen concentration attributed to the EGR control. This helps to suppress the stall of the internal combustion engine 10.

In some embodiments, the catalyst neutralization processor 65 may be configured to set the correction coefficient by the linear interpolation in accordance with the downstream-side oxygen concentration, provided that the correction coefficient for the downstream-side oxygen concentration at the predetermined first threshold is defined as zero and the correction coefficient for the downstream-side oxygen concentration at the predetermined second threshold is defined as one. Such a configuration helps to suppress the decrease in fuel economy caused by setting the EGR amount to zero, while preventing the stall of the internal combustion engine 10.

In some embodiments, the predetermined second threshold may be configured to be set to the value exceeding the range of the fluctuation of the downstream-side oxygen concentration occurring after the termination of the catalyst neutralization processing. Such a configuration helps to prevent the EGR amount reduction correction from being incorrectly executed due to the fluctuation of the downstream-side oxygen concentration that may occur when the vehicle is traveling in the normal mode.

In some embodiments, the EGR processor 63 may be configured to close the EGR valve 49 in executing the catalyst neutralization processing. Such a configuration helps to reliably prevent the oxygen concentration of the intake air from dropping due to the EGR control in executing the catalyst neutralization processing, suppressing the stall of the internal combustion engine 10.

According to at least one embodiment of the disclosure, it is possible to suppress a stall of an internal combustion engine caused by catalyst neutralization processing.

Although some example embodiments of the disclosure have been described in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

The limitations in the claims are to be interpreted broadly based on the language employed in the claims and not limited to examples described in this specification or during the prosecution of the application, and the examples are to be construed as non-exclusive.

As used in this specification and the appended claims, the singular forms "a", "an", and "the" include, especially in the context of the claims, are to be construed to cover both the singular and the plural, unless otherwise indicated herein or clearly contradicted by context.

Throughout this specification and the appended claims, unless the context requires otherwise, the terms "comprise", "include", "have", and their variations are to be construed to cover the inclusion of a stated element, integer, or step but not the exclusion of any other non-stated element, integer, or step.

The use of the terms first, second, etc. does not denote any order or importance, but rather the terms first, second, etc. are used to distinguish one element from another.

The term "substantially", "approximately", "about", and its variants having a similar meaning thereto are defined as being largely but not necessarily wholly what is specified as understood by one of ordinary skill in the art.

The term "disposed on/ provided on/ formed on" and its variants having a similar meaning thereto as used herein refer to elements disposed directly in contact with each other or indirectly by having intervening structures therebetween.

The processor 51 illustrated in FIGS. 1 and 2 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the processor 51. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the processor 51 illustrated in FIGS. 1 and 2.

1. An internal-combustion-engine control apparatus configured to control an internal combustion engine, the internal combustion engine comprising an internal combustion engine body, an intake passage and an exhaust passage each coupled to the internal combustion engine body, a catalyst provided in the exhaust passage, an oxygen sensor configured to detect an oxygen concentration on a downstream side of the catalyst, and an exhaust gas recirculator configured to circulate a part of exhaust gas into the intake passage, the internal-combustion-engine control apparatus comprising:
an exhaust gas recirculation processor configured to control the exhaust gas recirculator, based on an operating state of the internal combustion engine; and
a catalyst neutralization processor configured to
determine whether the oxygen concentration detected by the oxygen sensor is greater than or equal to a predetermined first threshold,
execute, when the oxygen concentration detected by the oxygen sensor is greater than or equal to the predetermined first threshold, catalyst neutralization processing in which fuel injection into the internal combustion engine is executed in a fuel-rich atmosphere comprising a richer air-fuel ratio than a stoichiometric air-fuel ratio to thereby consume at least a part of oxygen stored in the catalyst,
determine whether the oxygen concentration detected by the oxygen sensor in a predetermined time period after the fuel injection is resumed following termination of a fuel cut has increased from a value less than a predetermined second threshold to a value greater than or equal to the predetermined second threshold, the fuel cut being configured to stop the fuel injection when the internal combustion engine is operating, the predetermined second threshold being set less than the predetermined first threshold, and
correct, when the oxygen concentration detected by the oxygen sensor in the predetermined time period after the fuel injection is resumed following the termination of the fuel cut has increased to the value greater than or equal to the predetermined second threshold, an operation amount of the exhaust gas recirculator to reduce an exhaust gas recirculation amount.

2. The internal-combustion-engine control apparatus according to claim 1, wherein the catalyst neutralization processor is configured to set a correction coefficient by linear interpolation in accordance with the oxygen concentration, provided that the correction coefficient for the oxygen concentration at the predetermined first threshold is defined as zero and the correction coefficient for the oxygen concentration at the predetermined second threshold is defined as one.

3. The internal-combustion-engine control apparatus according to claim 1, wherein the predetermined second threshold is configured to be set to a value exceeding a range of fluctuation of the oxygen concentration occurring after termination of the catalyst neutralization processing.

4. The internal-combustion-engine control apparatus according to claim 1, wherein the exhaust gas recirculation processor is configured to close an exhaust gas recirculation valve in executing the catalyst neutralization processing.

5. A method of controlling an internal combustion engine, the internal combustion engine comprising an internal combustion engine body, an intake passage and an exhaust passage each coupled to the internal combustion engine body, a catalyst provided in the exhaust passage, an oxygen sensor configured to detect an oxygen concentration on a downstream side of the catalyst, and an exhaust gas recirculator configured to circulate a part of exhaust gas into the intake passage, the method comprising:
controlling the exhaust gas recirculator, based on an operating state of the internal combustion engine;
determining whether the oxygen concentration detected by the oxygen sensor is greater than or equal to a predetermined first threshold;
executing, when the oxygen concentration detected by the oxygen sensor is greater than or equal to the predetermined first threshold, catalyst neutralization processing in which fuel injection into the internal combustion engine is executed in a fuel-rich atmosphere comprising a richer air-fuel ratio than a stoichiometric air-fuel ratio to thereby consume at least a part of oxygen stored in the catalyst;
determining whether the oxygen concentration detected by the oxygen sensor in a predetermined time period after the fuel injection is resumed following termination of a fuel cut has increased from a value less than a predetermined second threshold to a value greater than or equal to the predetermined second threshold, the fuel cut being configured to stop the fuel injection when the internal combustion engine is operating, the predetermined second threshold being set less than the predetermined first threshold; and
correcting, when the oxygen concentration detected by the oxygen sensor in the predetermined time period after the fuel injection is resumed following the termination of the fuel cut has increased to the value greater than or equal to the predetermined second threshold, an operation amount of the exhaust gas recirculator to reduce an exhaust gas recirculation amount.

6. An internal-combustion-engine control apparatus configured to control an internal combustion engine, the internal combustion engine comprising an internal combustion engine body, an intake passage and an exhaust passage each coupled to the internal combustion engine body, a catalyst provided in the exhaust passage, an oxygen sensor configured to detect an oxygen concentration on a downstream side of the catalyst, and an exhaust gas recirculator configured to circulate a part of exhaust gas into the intake passage, the internal-combustion-engine control apparatus comprising circuitry configured to
control the exhaust gas recirculator, based on an operating state of the internal combustion engine,
determine whether the oxygen concentration detected by the oxygen sensor is greater than or equal to a predetermined first threshold,
execute, when the oxygen concentration detected by the oxygen sensor is greater than or equal to the predetermined first threshold, catalyst neutralization processing in which fuel injection into the internal combustion engine is executed in a fuel-rich atmosphere comprising a richer air-fuel ratio than a stoichiometric air-fuel ratio to thereby consume at least a part of oxygen stored in the catalyst,
determine whether the oxygen concentration detected by the oxygen sensor in a predetermined time period after the fuel injection is resumed following termination of a fuel cut has increased from a value less than a predetermined second threshold to a value greater than or equal to the predetermined second threshold, the fuel cut being configured to stop the fuel injection when the internal combustion engine is operating, the predetermined second threshold being set less than the predetermined first threshold, and
correct, when the oxygen concentration detected by the oxygen sensor in the predetermined time period after the fuel injection is resumed following the termination of the fuel cut has increased to the value greater than or equal to the predetermined second threshold, an operation amount of the exhaust gas recirculator to reduce an exhaust gas recirculation amount.
